(19) United States
(12) Patent Application Publication
(10) Pub. No.: US 2011/0211916 A1
(43) Pub. Date: Sep. 1, 2011

(54) APPARATUS FOR STORAGE VESSEL DEPLOYMENT AND METHOD OF MAKING SAME

(76) Inventors: Scott Raymond Frazier, Golden, CO (US); Jacob Lee Fitzgerald, Denver, CO (US); Brian Von Herzen, Minden, NV (US)

(21) Appl. No.: 13/038,119

(22) Filed: Mar. 1, 2011

Related U.S. Application Data
(60) Provisional application No. 61/309,415, filed on Mar. 1, 2010.
(60) Provisional application No. 61/364,364, filed on Jul. 14, 2010.
(60) Provisional application No. 61/364,368, filed on Jul. 14, 2010.

(51) Int. Cl. E02D 5/74; A01B 13/00; B23P 11/00

(52) U.S. Cl. 405/224; 172/721; 29/428

(57) ABSTRACT

An apparatus for storage vessel deployment includes a plow for deployment of a flexible vessel that includes a body having an outer wall and an inner wall extending along a bore passing through the body. The body also has an intermediate wall extending between the outer wall and the inner wall, wherein a vessel cavity is formed between the inner and outer walls that is configured to receive the flexible vessel in a pre-deployment configuration.

### CROSS-REFERENCE TO RELATED APPLICATION

The present application claims priority to U.S. Provisional Application 61/309,415 filed Mar. 1, 2010, to U.S. Provisional Application 61/364,364 filed Jul. 14, 2010, and to U.S. Provisional Application 61/364,368 filed Jul. 14, 2010, the disclosures of which are incorporated herein.

### BACKGROUND OF THE INVENTION

Embodiments of the invention relate generally to storage vessel deployment and, more particularly, to an apparatus for deploying a storage vessel.

Renewable energy (RE) sources offer an alternative to conventional power sources in an age of dwindling non-renewable energy sources and high carbon emissions. However, RE sources are often not fully exploited because many forms of renewable energy are not available when the peak electricity demand is present. For instance, RE sources may be most available during undesirable off-peak hours, or may be located in areas that are remote from population centers or locations where power is most needed, having to share the grid during peak hours along with all the other peak power sources.

RE sources may include hydro power, geothermal, Ocean Thermal Energy Conversion (OTEC), as examples. Hydro power, for instance, when combined with a reservoir is one RE source that can be throttled up and down to match or load-follow the varying power loads. Geothermal and OTEC are also good baseload RE resources; however, locations viable for their use tend to be limited. It is to be understood that an ocean thermal energy converter, while traditionally utilized across the thermocline of an ocean, can additionally apply to fresh bodies of water that have a temperature difference between surface water and deep water. RE sources may also include solar, wind, wave, and tidal, as examples. However these sources tend to be intermittent in their ability to provide power. Energy storage is thus desired for those sources to substantially contribute to the grid energy supply.

For instance, wind energy may be cost effective per kWh but often may not produce energy during peak demand. Wind energy is intermittent, varying uncontrollably with the wind speed, limiting its adoption as a primary power source for the grid. This problem can get worse as more intermittent RE sources of all kinds are added to the grid—as long as cost-effective storage is unavailable. Above 20% renewable energy fraction, electrical power grids often lose stability without energy storage to modulate energy supply and demand.

Cost-effective storage for the electrical grid has been sought from the beginning of electrical service delivery but is not yet available. The variation in power demand throughout a day, and season to season, requires generation assets that sit idle much of the time, which can increase capital, operations, and maintenance costs for assets used at less than full capacity. Also some generation assets are difficult to throttle or shut down and are difficult to return to full power in short periods of time. Energy storage can provide a buffer to better match power demand and supply allowing power sources to operate at higher capacity and thus higher efficiency.

Cost parameters of several leading storage technologies may be considered for large-scale energy systems and each technology has its own cost drivers. Pumped hydroelectric storage, for example, has been used for many decades and is often considered the standard by which other grid energy storage ideas are judged. It is efficient from an energy capacity standpoint, consumes no fuel upon harvesting the stored energy, but can only be deployed in limited locations and has high capital cost per unit power. Two nearby reservoirs with a substantial elevation change between then are typically required.

Compressed air energy storage (CAES) is an attractive energy storage technology that overcomes many drawbacks of known energy storage technologies. A conventional approach for CAES is to use a customized gas turbine power plant to drive a compressor and to store the compressed air underground in a cavern or aquifer. The energy is harvested by injecting the compressed air into the turbine system downstream of the compressor where it is mixed with, or heated by, natural gas-fired combustion air and expanded through the turbine. The system operates at high pressure to take advantage of the modest volume of the cavern or aquifer. The result is a system that operates with constant volume and variable pressure during the storage and retrieval process, which results in extra costs for the compressor and turbine system because of the need to operate over such a wide range of pressures. Underground CAES suffers from geographic constraints. Caverns may not be located near power sources, points of load or grid transmission lines. In contrast, a large majority of the electrical load in the industrialized world lies within reach of water deep enough for underwater CAES to be practical. Underwater CAES removes many of the geographic constraints experienced by underground CAES.

Also, an important factor for efficient compression and expansion of a fluid is dealing with the heat generated during compression and the heat required during expansion. Conventional CAES reheats air with natural gas (often by absorbing heat from the gas turbine exhaust) and gives up the heat of compression to the ambient environment. Such systems can include a thermal storage device to enable adiabatic operation. Such systems also often have separate equipment for compression and expansion phases, and therefore have a greater capital expense, as well as higher operating cost and complexity due to the use of natural gas. The result is that the power plant, when utilizing purchased off-peak power to charge the air reservoir can generate power during periods of peak demand, but with additional equipment and higher fuel costs.

Therefore, it would be desirable to design an apparatus capable of deploying a storage vessel for use in systems such as compressed air or compressed fluid systems in an efficient and cost-effective manner.

### BRIEF DESCRIPTION OF THE INVENTION

In accordance with one aspect of the invention, a plow for deployment of a flexible vessel includes a body having an outer wall and an inner wall extending along a bore passing through the body. The body also has an intermediate wall extending between the outer wall and the inner wall, wherein a vessel cavity is formed between the inner and outer walls that is configured to receive the flexible vessel in a pre-deployment configuration.

According to another aspect of the invention, a method for manufacturing a vessel deployment apparatus includes forming a first wall member to surround a bore volume and coupling a second wall member about the first wall member such that a vessel volume is formed between the first and second wall member portions that is capable of receiving a flexible vessel therein for deployment thereof. The method also includes coupling a third wall member to the first and second wall members.

According to yet another aspect of the invention, a vessel deployment apparatus having a bore extending therethrough includes a first wall member portion positioned at least about a section of the bore and includes a second wall member portion positioned about the first wall, wherein a volume between the first and second wall member portions is capable of receiving a flexible vessel therein for deployment of the flexible vessel. A third wall member portion is coupled between to the first and second wall member portions.

Various other features and advantages will be made apparent from the following detailed description and the drawings.

### BRIEF DESCRIPTION OF THE DRAWINGS

The drawings illustrate embodiments presently contemplated for carrying out the invention.

In the drawings:

FIG. 1 is an isometric view of a storage vessel deployment apparatus according to an embodiment of the invention.

FIG. 2 is a side view of the storage vessel deployment apparatus of FIG. 1 according to an embodiment of the invention with the outer wall thereof shown in phantom illustrating an engagement of a storage vessel with the apparatus.

FIG. 3 is an isometric view of a rear end of the storage vessel deployment apparatus of FIG. 1 according to an embodiment of the invention with a portion of the outer wall thereof cut away.

FIG. 4 is a side view of the storage vessel deployment apparatus of FIG. 1 according to another embodiment of the invention with the outer wall thereof shown in phantom illustrating an engagement of a storage vessel with the apparatus.

FIG. 5 is an isometric view of the storage vessel deployment apparatus of FIG. 1 in a deployment mode according to an embodiment.

FIG. 6 is an isometric view of a storage vessel deployment apparatus according to another embodiment of the invention.

FIG. 7 is an isometric view of a storage vessel deployment apparatus according to another embodiment of the invention.

FIG. 8 is a side view of the storage vessel deployment apparatus of FIG. 7 according to an embodiment of the invention with the outer wall thereof shown in phantom illustrating an engagement of a storage vessel with the apparatus.

FIG. 9 is an exploded isometric view of a storage vessel deployment apparatus according to another embodiment of the invention.

FIG. 10 is a schematic diagram illustrating general functionality of an energy system that can benefit from embodiments of the invention.

FIG. 11 is a schematic diagram illustrating a system having the functionality illustrated in FIG. 10 according to embodiments of the invention.

FIG. 12 is a schematic diagram illustrating basic components of a system positioned at sea that can benefit from an embodiment of the invention.

### DETAILED DESCRIPTION

Embodiments of the invention include a deployment apparatus for installation of storage vessels on land or on a floor of a body of water. Such bodies of water may include, for example, an ocean, sea, lake, reservoir, gulf, harbor, inlet, river, or any other manmade or natural body of water. As used herein, “sea” refers to any such body of water, and “sea floor” refers to the floor thereof “Sediment” (e.g., “sea floor sediment”), as used herein, refers to marine material from the bottom or sea floor of the sea and may include, by way of example, gravel, sand, silt, clay, mud, organic or other material settled onto the floor of the sea. Embodiments of the invention include apparatus useful for deploying storage vessels within a ballast material such as a sea floor or land.

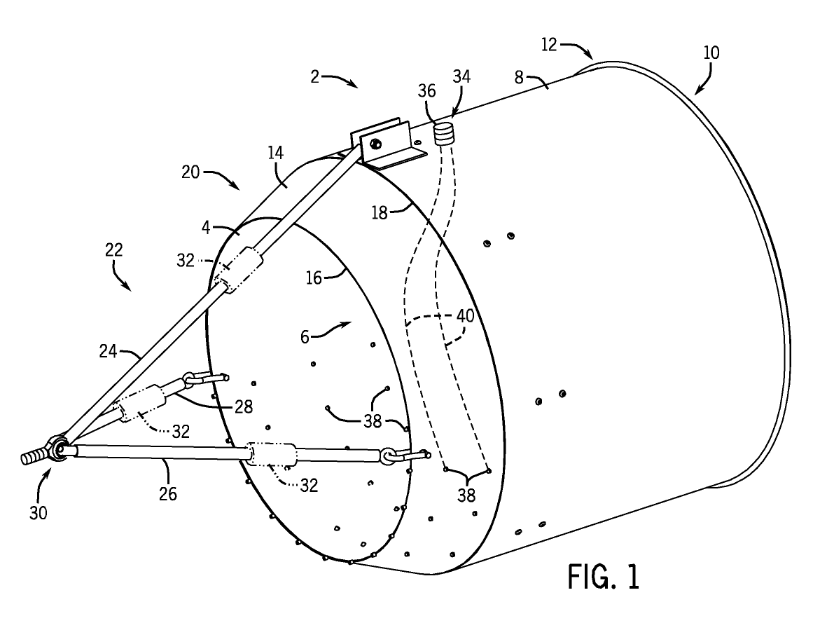

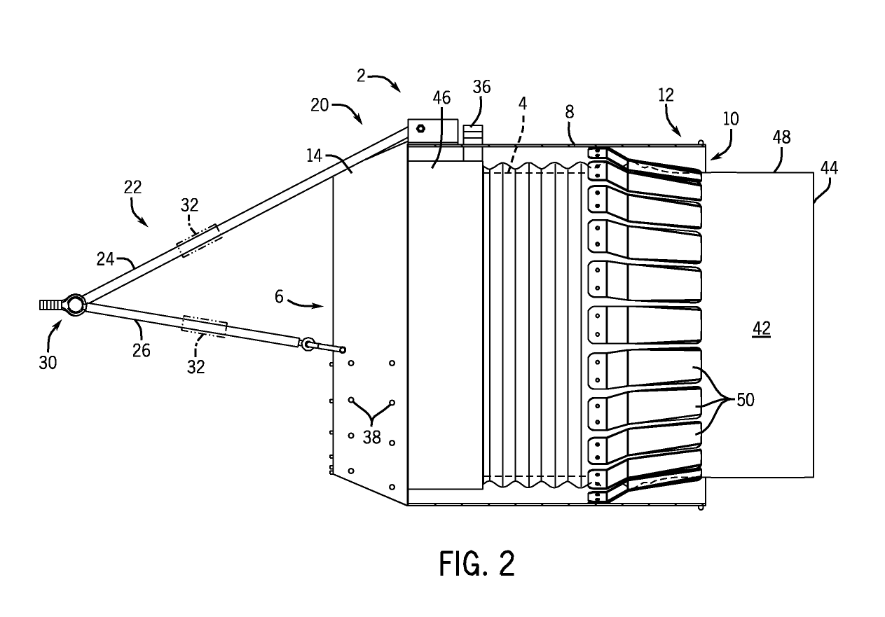

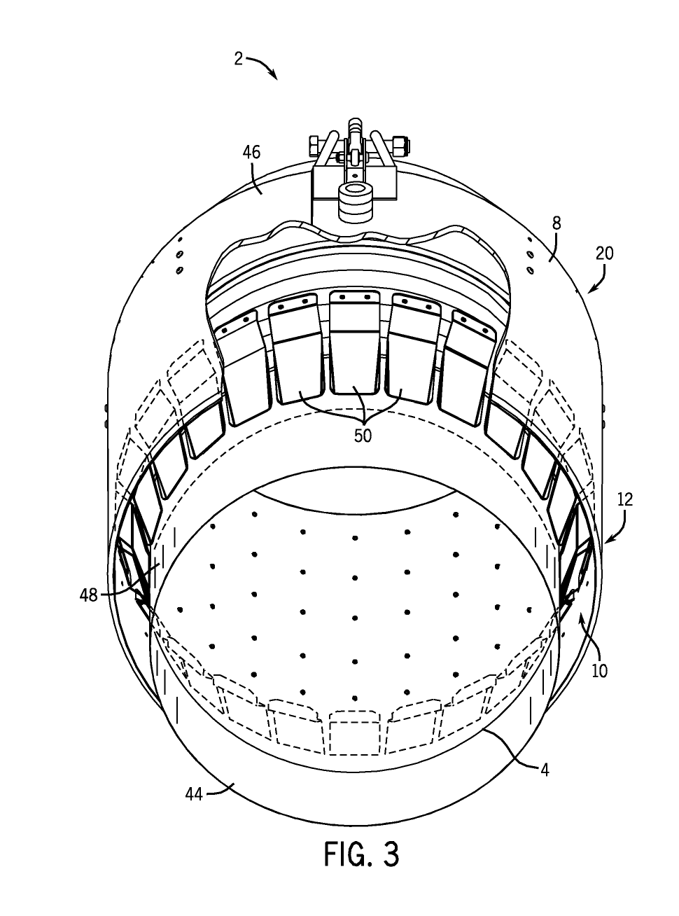

FIG. 1 shows a storage vessel deployment apparatus 2 according to an embodiment of the invention. Plow 2 has a body that includes an inner wall or wall member 4 that surrounds at least a portion of a bore 6 extending through apparatus 2. Inner wall 4 may in part define a boundary of bore 6, but bore 6 may extend beyond inner wall 4 through apparatus 2. The body of plow 2 also includes an outer wall or wall member 8 positioned to surround inner wall 4, and a vessel cavity 10 is formed between inner wall 4 and outer wall 8 such that a storage vessel (shown in FIGS. 2 and 3) may deploy therefrom toward a rear end 12 of plow 2. An intermediate wall or wall member 14 of the body is coupled between leading edges 16, 18 of inner wall 4 and outer wall 8, respectively, at a front end 20 of apparatus 2. Intermediate wall 14 thus spans the distance between inner wall 4 and outer wall 8. In this embodiment, leading edge 16 of inner wall 4 extends farther toward the front of plow 2 than leading edge 18 of outer wall 8. In this manner, ballast material flowing along intermediate wall 102 is directed away from plow 2.

A towing apparatus 22 is coupled to plow 2 to allow a towing force to be transferred thereto. In one embodiment, towing apparatus 22 may include a plurality of tow members, such as members 24, 26, and 28, joined together at a tow point 30. Members 24-28 may be, for example, chains, wires, solid metal bars, or other structural element with sufficient cross section to carry requisite tensile loads or in some instances compressive loads. Tow point 30 may be coupled to a tow cable or line (not shown) for towing plow 2 through land or through a sea floor. A device 32 such as a turnbuckle or linear actuator may be coupled to one or each of members 24-28 to direct the vertical or horizontal steering of plow 2. For example, when coupled to member 24, device 32 may be manipulated to change a length of member 24 between tow point 30 and plow 2, which may be used to vary a pitch or vertical steering of plow 2 so that the depth of plow 2 may be increased or decreased. In another example, when coupled to member 26 or member 28, device 32 may be manipulated to change a length thereof between tow point 30 and plow 2, which may be used to vary a yaw or horizontal steering of plow 2.

It is contemplated that inner wall 4, outer wall 8, and intermediate wall 14 may be constructed of a rigid material such as metal and/or plastic. Using materials with a low coefficient of friction helps plow 2 to move more easily through ballast material such as land or sea floor sediment. To help reduce friction caused by moving plow 2 through ballast material, plow 2 may include a fluid injection system 34 for injecting a fluid in between the ballast material and the inner wall 4, outer wall 8, or intermediate wall 14. Fluid injection system 34 includes an inlet port 36 (shown coupled to outer wall 8) coupled to a plurality of outlet ports 38 via one or more conduits 40. It is contemplated that each outlet port 38 may be coupled to a respective conduit 40 or that all outlet ports 38 may be coupled to a single conduit. Stronger fluid injection may be used on the leading edge of the plow to cut through the sediments as the system is deployed.

FIG. 2 is a side view of plow 2 according to an embodiment of the invention with outer wall 8 shown in phantom to illustrate a storage vessel 42 positioned within vessel cavity 10. FIG. 3 is an isometric view of rear end 12 of plow 2 having a portion of outer wall 8 cut away to illustrate storage vessel 42 positioned within vessel cavity 10. Referring to FIGS. 2 and 3, storage vessel 42 has an enclosed head end 44 and an open tail end 46. Tail end 46 fits inside vessel cavity 10 and around inner wall 4. The vessel wall 48 between head end 44 and tail end 46 is gathered in an accordion-style fashion and is also positioned about inner wall 4. A plurality of tension members 50 is coupled to outer wall 8, and each tension member 50 extends toward inner wall 4. Tension members 50 are stiff but flexible and along with inner wall 4 provide a tension force on storage vessel 42. For deployment of storage vessel 42, inner wall 4 is positioned inside storage vessel 42. During deployment of storage vessel 42, as ballast material is directed through bore 6 and into head end 44 of storage vessel 42, storage vessel 42 begins to unravel and extend outward from vessel cavity 10. The tension force provided by tension members 50 and inner wall 4 assists to reduce wrinkles and other folds in the vessel wall 48 of storage vessel 42 as storage vessel 42 is deployed.

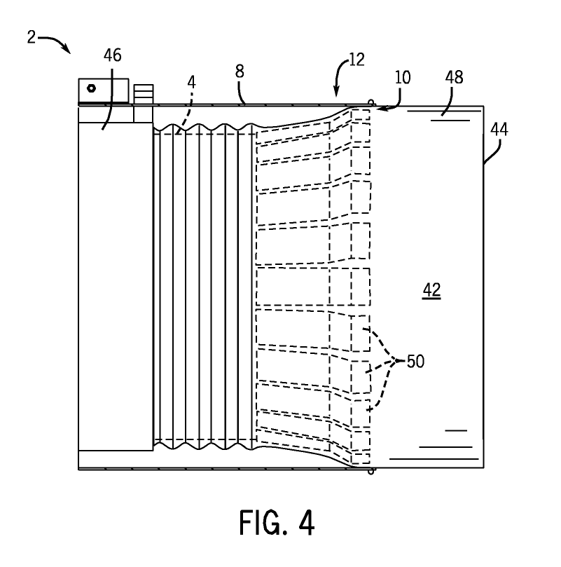

FIG. 4 shows an alternate embodiment for the tension members 50 shown in FIG. 2. As shown in FIG. 4, tension members 50 is coupled to inner wall 4, and each tension member 50 extends toward outer wall 8. For deployment of storage vessel 42, both inner wall 4 and tension members 50 are positioned inside storage vessel 42. The tension force provided by tension members 50 and outer wall 8 assists to reduce wrinkles and other folds in the vessel wall 48 of storage vessel 42 as storage vessel 42 is deployed.

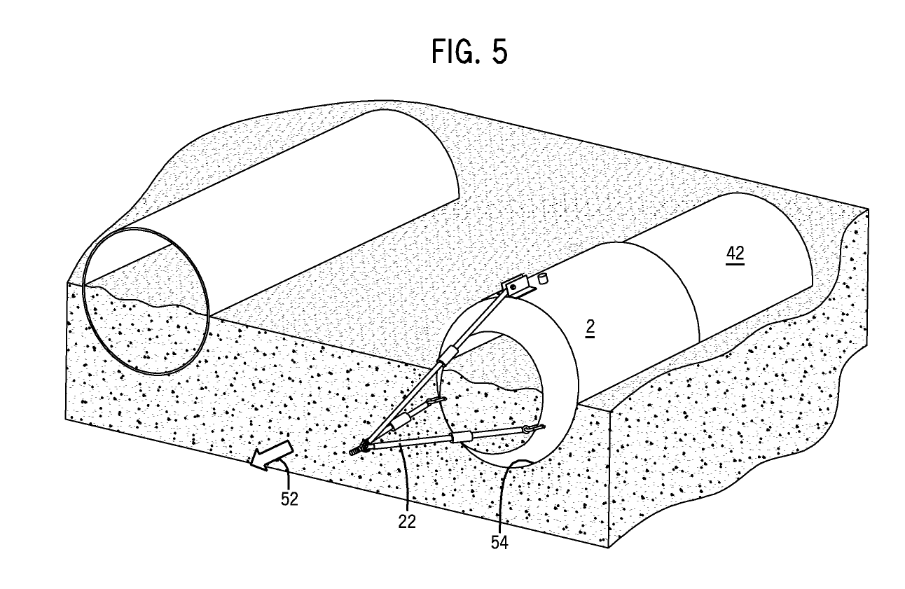

FIG. 5 is an isometric view of plow 2 in a deployment mode according to an embodiment of the invention. Plow 2 is positioned on the ground or on the sea floor, and a towing force 52 applied to towing apparatus 22 acts to pull plow 2 in a forward direction. As plow 2 is pulled forward, a kerf 54 is cut into the ground or sea floor, possibly using a fluidic knife near the leading edge of plow 2, and ballast material such as sand, silt, clay, mud, dredgings or sediment from the ground or sea floor in situ is cored or dredged and flows through bore 6 and into storage vessel 42. As ballast material is deposited into storage vessel 42, storage vessel 42 is deployed from plow 2 and remains within kerf 54. In this manner, the material at the deployment site ballasts the storage vessel, and other methods for ballasting the storage vessel need not be used. However, other ballasting methods may also be used to reinforce maintaining the position of the storage vessel at the deployment site. When storage vessel 42 becomes fully deployed, plow 2 is separated therefrom, and plow 2 may be fitted with another storage vessel so that a field or array of storage vessels may be deployed.

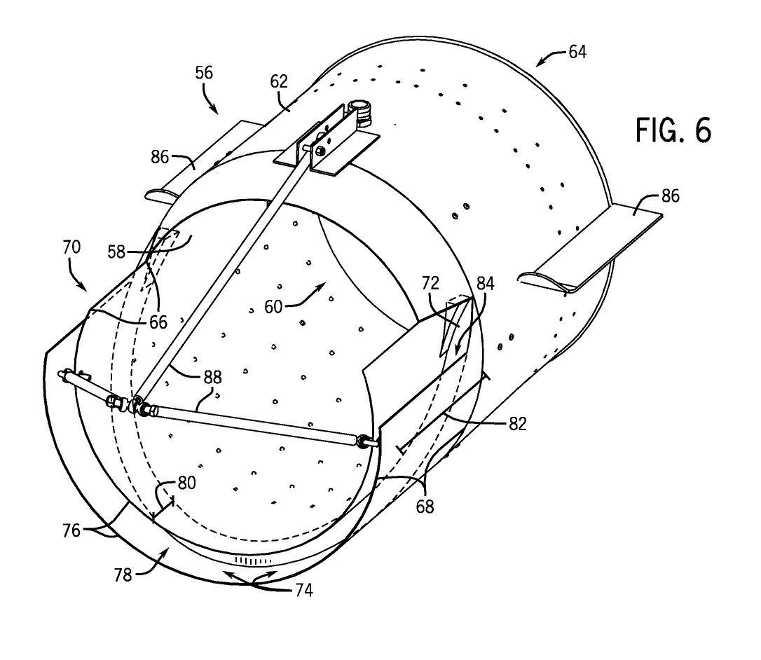

FIG. 6 is an isometric view of a plow 56 according to another embodiment of the invention. Similar to plow 2 of FIGS. 1-5, plow 56 has a body that includes an inner wall 58 that surrounds at least a portion of a bore 60 extending therethrough. The body of plow 56 also includes an outer wall 62 positioned to surround inner wall 58, and a vessel cavity 64 is formed between inner wall 58 and outer wall 62 such that a storage vessel (not shown) may deploy therefrom according to a deployment manner described herein.

Inner wall 58 and outer wall 62 include elongated portions 66, 68 forming a kerf shovel 70. An intermediate wall 72 extends between elongated portions 66, 68 to form a passageway 74 for material to flow as plow 56 is translated therethrough. In one embodiment, the depth of passageway 74 from a leading edge 76 of elongated portions 66, 68 increases as passageway 74 extends away from a central portion 78 thereof. That is, a first depth 80 may exist at the central portion 78, and a second depth 82, greater than first depth 80, may exist at an exit 84 of passageway 74. Passageway 74 allows for displacing a portion of the kerf material on the surface of the material through which plow 56 is translated. Depositing the kerf material on the surface in this manner allows for displacing the material while reducing the need to compress such material within the kerf or within the storage vessel. According to an embodiment of the invention, the distance between inner wall 58 and outer wall 62 at central portion 78 may also be smaller than the distance between inner wall 58 and outer wall 62 at exit 84.

Also shown in FIG. 6 are depth guides 86 configured to ride or slide along a surface of the material through which plow 56 is translated. Depth guides 86 act to exert a counter force to a downward moment exerted on plow 56 via kerf shovel 70 or via a towing apparatus 88 coupled thereto. Depth guides 86 may be adjustable along the circumference of outer wall 62 to control the depth of the kerf cut by plow 56. In one embodiment, depth guides 86 are ski-shaped; however, it is contemplated that other shapes are also possible.

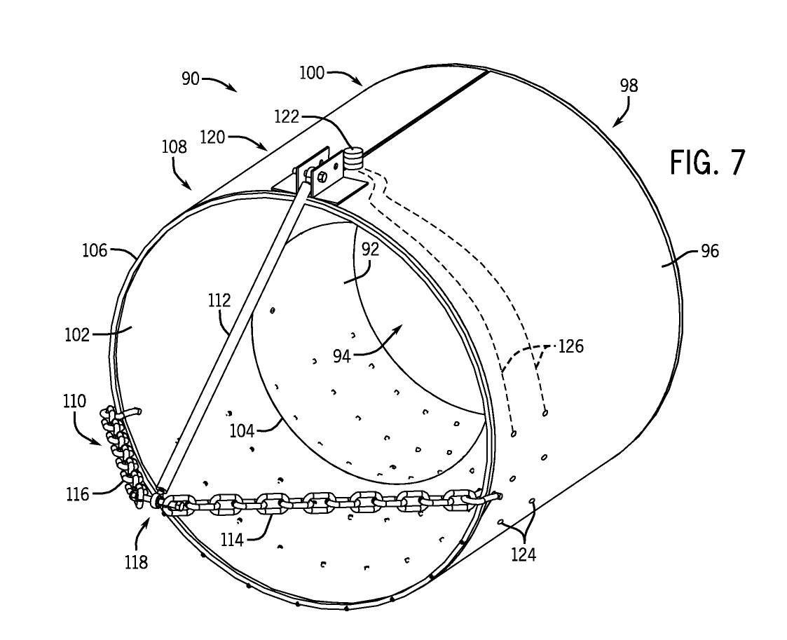

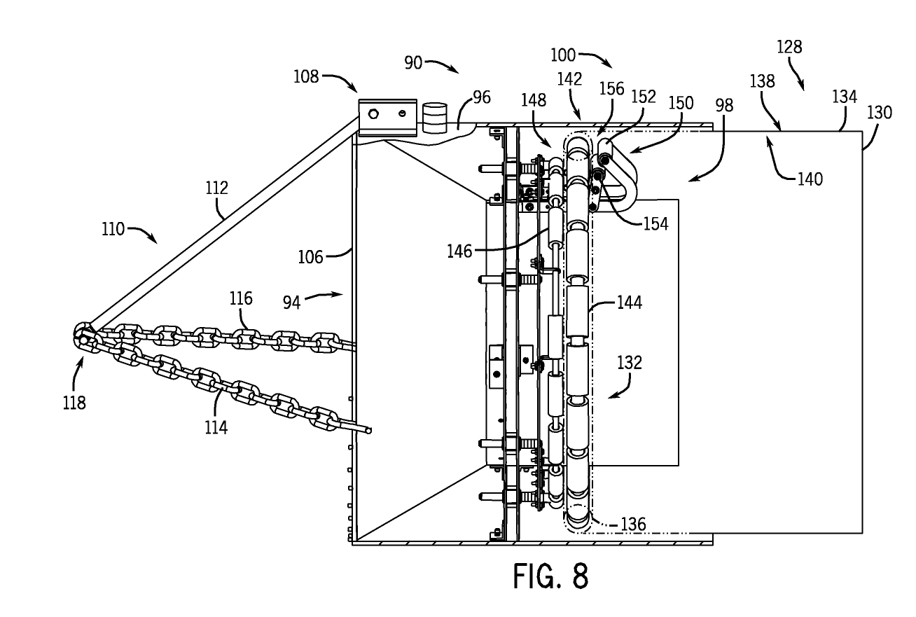

FIG. 7 shows a storage vessel deployment apparatus 90 according to an embodiment of the invention. Plow 90 has a body that includes an inner wall 92 that surrounds at least a portion of a bore 94 extending therethrough. Inner wall 92 may in part define a boundary of bore 94, but bore 94 may extend beyond inner wall 92 through apparatus 90. The body of plow 90 also includes an outer wall 96 positioned to surround inner wall 92, and a vessel cavity 98 is formed between inner wall 92 and outer wall 96 such that a storage vessel (shown in FIG. 8) may deploy therefrom toward a rear end 100 of plow 90. An intermediate wall 102 of the body is coupled between leading edges 104, 106 of inner wall 92 and outer wall 96, respectively, at a front end 108 of apparatus 90. Intermediate wall 102 thus spans the distance between inner wall 92 and outer wall 96. In this embodiment, leading edge 106 of outer wall 96 extends farther toward the front of plow 90 than leading edge 104 of inner wall 92. In this manner, ballast material flowing along intermediate wall 102 is directed through bore 94 and into the attached storage vessel.

A towing apparatus 110 is coupled to plow 90 to allow a towing force to be transferred thereto. In one embodiment, towing apparatus 110 may include a plurality of tow members, such as a solid bar 112 and chains 114, 116, joined together at a tow point 118. Tow point 118 may be coupled to a tow cable or line (not shown) for towing plow 90 through land or through a sea floor. Tow apparatus 110 may include length manipulation devices such as devices 32 illustrated in FIG. 1 for varying the lengths of tow members 112-116 such that the vertical or horizontal steering of plow 90 may be affected.

To help reduce friction caused by moving plow 90 through ballast material, plow 90 may include a fluid injection system 120 for injecting a fluid into the ballast material as it slides along inner wall 92, outer wall 96, or intermediate wall 102. Fluid injection system 120 includes an inlet port 122 (shown coupled to outer wall 96) coupled to a plurality of outlet ports 124 via one or more conduits 126. It is contemplated that each outlet port 124 may be coupled to a respective conduit 126 or that all outlet ports 124 may be coupled to a single conduit.

FIG. 8 is a side view of plow 90 according to an embodiment of the invention with outer wall 96 shown in phantom to illustrate a storage vessel 128 positioned within vessel cavity 98. Storage vessel 128 has an enclosed head end 130 and an open tail end 132. Beginning at the tail end 132, the wall 134 of storage vessel 128 is rolled into an inward torus 136 in which an outer surface 138 thereof is rolled inward toward an inner surface 140 thereof. The torus 136 thus created is designed to fit inside vessel cavity 98.

A roller assembly 142 positioned within vessel cavity 98 is designed to engage torus 136 and provide stiffness to the storage vessel packaged as a torus. Roller assembly 142 includes a first assembly of wheels or rollers 144 rolled together with storage vessel 128 such that first assembly 144 is positioned within torus 136. A second assembly of wheels or rollers 146 is coupled to plow 90 and engages the inward-rolled torus 136 on a first side 148 thereof. A retainer or tension assembly 150 has one or more rollers 152, 154 that engage torus 136 on a second side 156 thereof and acts to ensure engagement of second assembly 146 with torus 136. In one embodiment, tension assembly 150 applies tension via a spring force. As storage vessel 128 is deployed, the size of torus 136 diminishes due to an unwinding of torus 136. Unwinding torus 136 in this manner allows for a reduction of that number of wrinkles and other folds that appear in the deployed vessel.

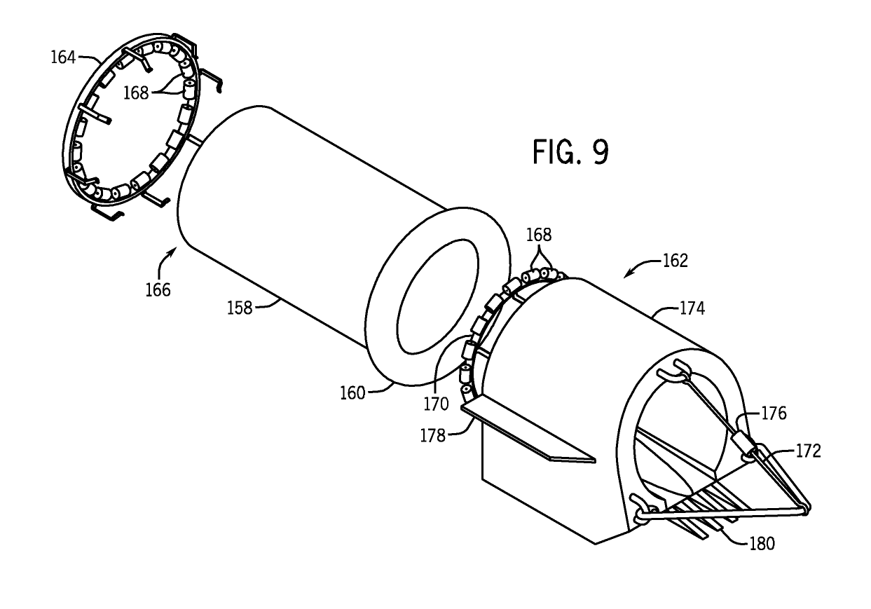

FIG. 9 illustrates an exploded view of installing a rolled up storage vessel 158 having a torus or toroid section 160 to an annular plow or dredge 162. Annular dredge 162 has a hollow body. A first hoop 164 is positioned or slipped around a head end 166 of storage vessel 158. First hoop 164 includes a plurality of tubular rollers 168 configured to abut toroid section 160 to allow toroid section 160 to unroll as storage vessel 158 is deployed. Annular dredge 162 includes a second hoop 170 that is inserted into an interior of storage vessel 158 so as to oppose first hoop 164 when first hoop 164 is secured to annular dredge 162. Assembly may be eased by assembling storage vessel 158 into annular dredge 162 prior to introducing the installation apparatus into the water for its journey to the sea floor.

Annular dredge 162 includes a towing apparatus 172 for pulling or towing annular dredge 162 through the sea floor. Towing apparatus 172 includes a plurality of wires or solid metal bars coupled to the body 174 of annular dredge 162. A turnbuckle 176 allows for pitch compensation. In addition, one or more depth controlling devices 178 such as a pair of fins on opposite sides of body 174 may be used to maintain the depth level of annular dredge 162.

As annular dredge 162 is towed forward, a biasing apparatus (cattle guard) 180 having teeth or guard pieces causes annular dredge 162 to dig into the ground or sea floor. As dirt, silt, or other materials pass through annular dredge 162, storage vessel 158 is filled with the dirt or sediment including silt and other materials, and the toroid section 160 unrolls as the head end 166 of storage vessel 158 stays in place. In one embodiment, the depth of annular dredge 162 is set such that storage vessel 158 is filled half way with dirt or sediment. However, the level of vessel filling can be adjusted based on design requirements. Deployment of storage vessel 158 ends when the vessel material making up toroid section 160 finishes at its tail end. During deployment, a section of storage vessel 158 leading up to and including the tail end may be inserted deeper into the dirt or sediment than the rest of storage vessel 158 to introduce a localized slope in the last part of the air vessel 158.

Depth controlling devices 178, which may resemble that shown in FIG. 6 or another shape providing a similar function, maintain the depth level of annular dredge 162. In this manner, while biasing apparatus 180 causes a downward moment to be applied to annular dredge 162, skis 178 prevent annular dredge 162 from digging too deeply into the dirt or sediment. Accordingly, the dirt or sediment level flowing into annular dredge 162 may be closely controlled.

It is contemplated that elements or portions of the embodiments described herein may be interchanged with one another. For example, any of the embodiments may include a vessel cavity capable of receiving one or all of the accordion-style, the inner-rolled torus, or the outer-rolled torus pre-deployment configurations. Likewise, any of the embodiments may incorporate one of the intermediate wall configurations detailed herein.

In addition, it is contemplated that the shape of the bore extending through the deployment apparatus embodiments described above may be other than that illustrated in the figures. That is, a cross-sectional bore shape other than a circle is envisioned. As an example, an oval or square cross-sectional bore shape or the like may be used.

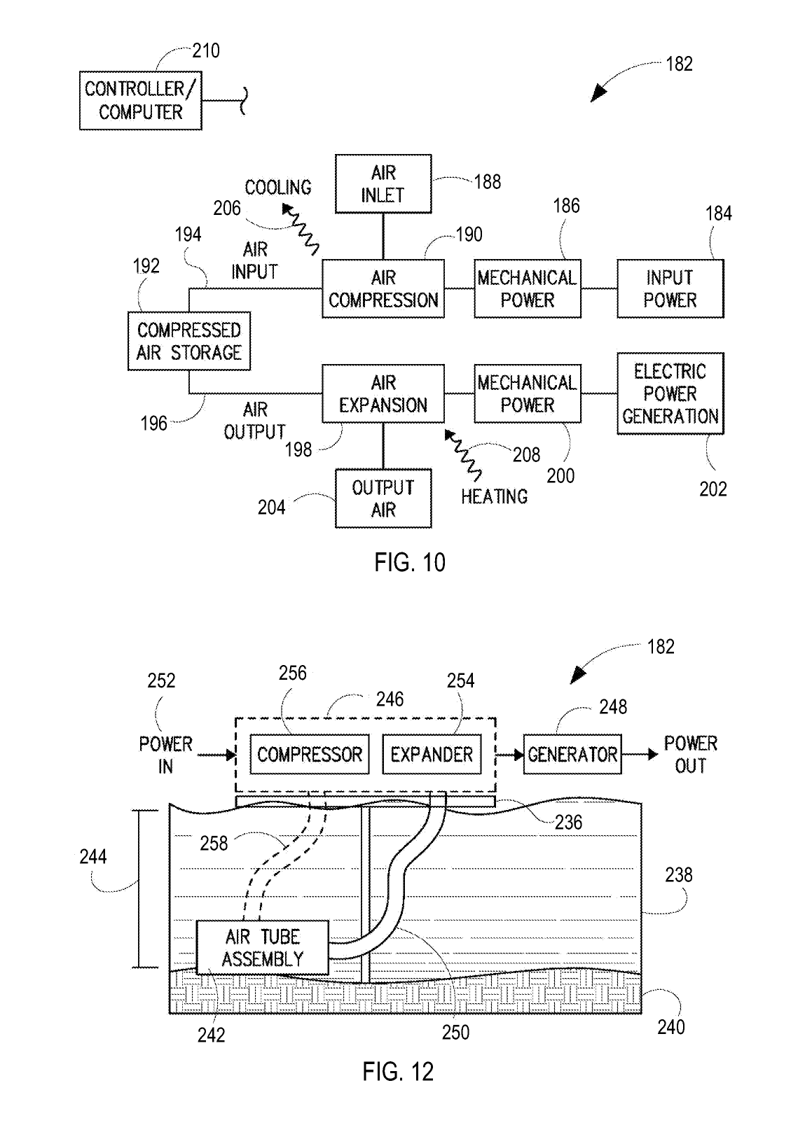

Embodiments of the storage vessel deployment apparatus described herein are beneficial in the installation of renewable energy systems or other systems that help reduce greenhouse gas emissions. For example, energy systems that compress and store air or other fluid may incorporate an array of storage vessels that can benefit from the storage vessel installation apparatus embodiments described herein. FIGS. 10-12 describe embodiments of exemplary energy systems that can take advantage of the storage vessel deployment and installation offered by the deployment apparatus described above.

Referring to FIG. 10, a general functionality of embodiments of a compressed air energy storage (CAES) system 182 is illustrated. System 182 includes input power 184 which can be, in embodiments of the invention, from a renewable energy source such as wind power, wave power (e.g., via a “Salter Duck”), current power, tidal power, or solar power, as examples. In another embodiment, input power 184 may be from an electrical power grid. In the case of a renewable energy (RE) source, such a source may provide intermittent power. In the case of an electrical power grid, system 182 may be connected thereto and controlled in a fashion that electrical power may be drawn and stored as compressed fluid energy during off-peak hours such as during late evening or early morning hours, and then recovered during peak hours when energy drawn from system 182 may be sold at a premium (i.e., electrical energy arbitrage), or to augment base load power systems such as coal to provide peaking capability by storing inexpensive base load power. Another way of operating would be to use system 182 as a base power supply to provide low-cost power therefrom in a generally static mode in lieu of a conventional power source such as coal, and use conventional power sources (e.g., natural gas, diesel, etc.) as peak power systems to provide transient power as the load fluctuates and exceeds the supply from system 182, thus reducing the average cost of power.

Also, system 182 is not limited to the aforementioned power sources, but applicable to any power source, including intermittently available power sources, or sources from which may be drawn during low-cost or off-peak hours and sold during a period that is desirable, such as during a peak electrical load or generating-plant outage. Further, system 182 is not limited to a single input power 184 but may include multiple sources which may be coupled thereto. In other words, multiple and combined power sources may be included in a single system as input power 184. Input power 184 is coupled to mechanical power 186 to compress fluid from a fluid inlet 188.

Fluid compression 190 may be from a device that can both compress and expand a fluid, depending on direction of rotation, such as a Wankel-type compressor/expander (C/E). However, the invention is not so limited, and any compressor that uses mechanical power to compress a fluid may be implemented according to embodiments of the invention, and any expander that decompresses a fluid to generate mechanical energy may be implemented according to embodiments of the invention. In embodiments of the invention the C/E is capable of generating between 0.2 MW and 3 MW of power; however, the invention is not so limited and may be capable of generating any range of power commensurate with system requirements that may include a power as low as 0.0001 MW and a power as high as 5 MW or greater. Thus, fluid compression 190 occurs as a result of mechanical power 186 using fluid input 188. Fluid compression 190 may occur in one or multiple cycles, and cooling may be introduced via pumps and heat exchangers, between stages, as is known in the art. Cooling may also be achieved through direct contact between the compressed fluid and a cooling fluid. Fluid from fluid compression 190 is conveyed to compressed fluid storage 192 via a fluid input 194. Also, compressed fluid storage 192 may be a vessel or other conformal fluid containment device that may be ballasted within a body of water such as a lake, reservoir (natural or man-made), or sea, using sediment as ballast, and at a depth to which fluid may be compressed and stored for later extraction. As such, the volume of fluid is stored nearly isobarically as a function of the amount of fluid therein and as a function of its depth within the body of water.

The fluid storage vessels or tubes may be rated to 50° C. In one compressor design according to an embodiment of the invention, where the heat of compression is recovered and stored, the expected exit temperature of the fluid from the expander into the fluid hose is only about 5-10° C. above the water temperature. Where only ambient water is used to cool the compression stages and there is no heat exchanger after the final stage, the temperature of the fluid into the fluid hose may be 30° C. above ambient, or 45° C. in the case of a 15° C. surface ocean temperature. If the tube temperature limit is exceeded for any reason, a temperature alarm can shut down the compressor. One or more temperature sensors may be positioned along the length of a fluid storage tube in a CAES system such that the temperature of the fluid storage tube may be monitored. For example, a temperature alarm may indicate to a system operator that a temperature limit has been reached or exceeded. In addition, an alarm shutdown on the system compressor may cause the compressor to stop supplying compressed fluid to the affected fluid tube to lessen or prevent damage to the fluid storage tube or to the fluid hose connected to the affected fluid storage tube. The vessel experiences constant pressure due to the variable-volume design and thus no additional heating occurs within the vessel.

When it is desirable to draw stored energy from system 182, compressed fluid may be drawn from compressed fluid storage 192 via fluid output 196 and fluid expansion 198 occurs. As known in the art, fluid expansion 198 results in available energy that may be conveyed to, for instance, a mechanical device, which may extract mechanical power 200 for electrical power generation 202, which may be conveyed to a grid or other device where it is desirable to have electrical power delivered. Outlet fluid 204 is expelled to the environment at generally standard or ambient pressure. In embodiments of the invention, mechanical power 200 may be produced from, as an example, a Wankel-type expander. Further, as will be discussed, mechanical power 186 for fluid compression 190 and mechanical power 200 derived from fluid expansion 198 may be via the same device (i.e., a compression/expansion or “C/E” device) or via a different or separate device within system 182.

In principle, a C/E may be used in an isothermal operation, an adiabatic operation, or a combination thereof. In another example, a C/E may be implemented that does not use a distinct heat exchanger and does not use a thermal reservoir. As is known in the art, when a fluid is compressed, it heats, and when a fluid is expanded, it cools. As such, embodiments of the invention include forced-convection cooling 206 to cool the fluid from fluid compression 190 and forced-convection heating 208 to heat the fluid from fluid expansion 198. Because fluid storage occurs at generally ambient temperature and pressure (i.e., at depth within the body of water as discussed), both cooling 206 for fluid compression 190 and heating 208 after fluid expansion 198 may be performed using the vast amount of fluid that surrounds system 182 (i.e., lake or seawater) or with a constructed body of water for implementations where the thermal storage on land is preferred. As such, system 182 may be operated, in some embodiments, in a generally isothermal manner that cools the fluid to near ambient during compression stage(s) and heats the fluid to near ambient during expansion stage(s). In other embodiments, system 182 may be operated in a generally adiabatic manner where energy from compression is stored via a controlled heat transfer process to a thermal storage tank, and energy to heat the fluid after expansion is likewise drawn from the energy stored in the storage tank, having relatively little heat exchange with the surrounding environment. In such fashion, the system includes a way to modulate or recover the sensible heat in the compressed fluid. However, in either case, pumps and heat exchangers may be employed to cool at desired locations in the system, as understood in the art.

In yet another embodiment, energy from fluid compression 190 is not stored per se, but water is selectively drawn into system 182 by taking advantage of the natural temperature difference between the surface water temperature and the temperature in the depths. In such an embodiment, cooling 206 during fluid compression 190 may be performed using relatively cold water obtained from the depths (i.e., well below water surface), and heating 208 during fluid expansion 198 may be performed using relatively warm water obtained from near the water surface. Utilizing this temperature difference in this manner is actually adding a heat engine cycle on top of the energy storage cycle, thus making it conceivable that more energy would be extracted than was stored, due to the thermal energy input of the water body.

System 182 includes a controller or computer 210 which may be controllably linked to components of system 182.

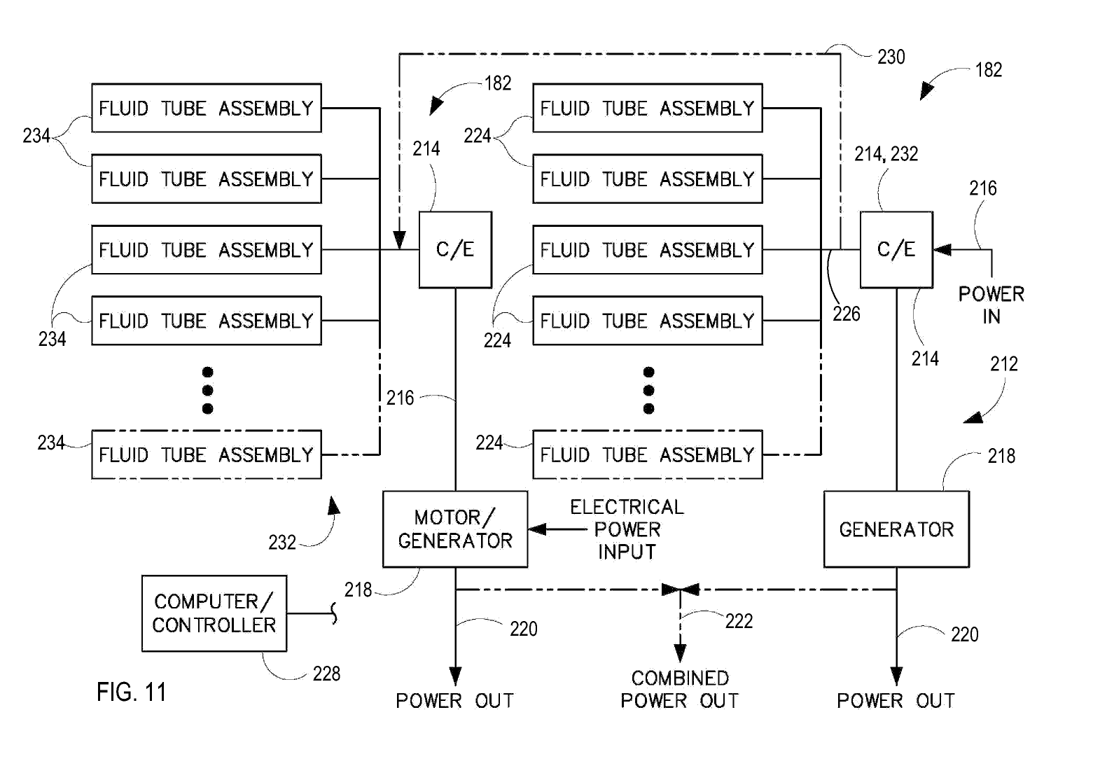

Referring now to FIG. 11, multiple systems such as system 182 of FIG. 10 may be deployed using embodiments of the invention. As will be described in further detail with respect to additional figures below, each system 182 may include a unitary or bi-directional compressor/expander (C/E) unit that is coupled to a fluid storage tube assembly that is positioned well below the surface of a water body. Each C/E is coupled to an energy source and a generator. The energy source may be a renewable source such as wind or wave power, or it may be from the generator itself, which is caused to operate as a motor having energy drawn from a power grid or from a renewable source such as a solar photovoltaic array.

Thus, FIG. 11 illustrates an overall system 212 having a plurality of systems 182 as illustrated in FIG. 10 and in subsequent figures and illustrations. Each system 182 includes a C/E 214 configured having a power input 216 and also coupled to a generator 218 (or motor/generator). Each generator 218 is configured having a respective power output 220. In one embodiment, each power output 220 is coupled separately to a load or utility grid; however, in another embodiment as illustrated, multiple power outputs 220 from two or more generators 218 may be combined to output a combined power output 222 to a load or utility grid.

Each C/E 214 is coupled to a fluid storage tube assembly 224, which, as will be further discussed, is positioned at depth and is configured to receive compressed fluid from a respective C/E 214. According to embodiments of the invention, each C/E 214 may be coupled to multiple fluid storage tube assemblies 224 via a tube or pipe 226. As such, a single C/E 214 may be coupled to a vast number of fluid-storage assemblies 224 and may be limited by the number of feed lines and the terrain on which the fluid storage tube assemblies 224 are positioned, as examples. Operation of overall system 212 may be controlled via a computer or controller 228, and one skilled in the art will recognize that each system 182 may include control valves, pressure sensors, temperature sensors, and the like, distributed throughout. Controller 228 is configured to pressurize fluid and direct the pressurized fluid to pass from C/E 214 or stages thereof to fluid storage tube assemblies 224 when power is available from the power source, and direct the pressurized fluid to pass from fluid storage tube assemblies 224 to C/E 214 or stages thereof and expand the pressurized fluid when power is selectively desired to be drawn from fluid storage tube assemblies 224.

As such, overall system 212 may be deployed in a modular fashion having multiple systems 182 (only two of which are illustrated in FIG. 11). Accordingly, this modularity provides system resilience and an ability to swap units in the field with minimum overall system downtime by allowing a portion of the system to be taken offline while the rest of the system continues to operate. Modularity also enables separate systems to operate simultaneously in different modes (i.e., one system collects/stores energy while another generates power). Thus, multiple CEs may be ganged together, as illustrated in FIG. 11, enabling modularity. And, each system 182 may be controlled in a fashion where, for instance, an individual fluid storage tube assembly 224 may be decoupled or isolated from its respective C/E 214. Accordingly, during operation, individual systems 182 or components of an individual and specific system 182 may be removed from service for trouble-shooting, repair, or routine maintenance. Thus, the modularity provides ease of servicing that enhances overall reliability, since the overall system 212 would not need to be shut down for servicing.

Further, because of the modularity of overall system 212, additional systems 182 may be added incrementally thereto, or additional storage may be added to each system 182 during operation. Thus, as power demands change over time (i.e., population growth or decrease in a given service area), power and/or storage capacity may be added or removed in a modular fashion consistent with that illustrated in FIG. 11, over time and in concert with changing system requirements. Thus, a modular system is expandable and other systems may be constructed and brought online with minimal impact to overall system downtime and operation.

Additionally, systems 182 of overall system 212 may be operated in separate fashions from one another simultaneously. For instance, in one portion of an array of systems 182, one of the systems 182 may be exposed to a high wind and thus operated in compression mode to store energy therefrom in its respective fluid storage tube assembly 224. However, at the same time, another one of the systems 182 may be in an area receiving little or no wind and thus operated in expansion mode to draw energy from its respective fluid storage tube assembly 224.

As such, overall system 212 may be operated in a flexible fashion that allows multiple modes of operation, and also may be configured in a modular fashion to allow portions thereof to be temporarily shut down for maintenance, repair, and operation, or permanently decommissioned, without having to shut down the overall system 212.

Further, configuration and operation of overall system 212 is in no way limited to the examples given. For instance, instead of wind energy, systems 182 may be coupled to a wave energy source or a water current source, as further examples. Systems 182 may each employ multiple C/Es 214, or C/Es 214 may be configured to share fluid storage therebetween. Thus, in one example, an auxiliary feed line 230 may be positioned and configured to separately couple one C/E 232 of one system 182 with fluid storage tube assemblies 234 of another system. In such fashion, storage capacity of fluid storage tube assemblies 234 may be used during, for instance, repair or maintenance of one C/E 232. In addition, rerouting, an example of which is shown in feed line 230, enables the cooperative use of multiple C/E's 214 and 232 to additional advantage, including modularity, system resilience, incremental expandability of power capacity, field-swappability of C/E units, and the ability to operate one C/E in compression mode and another C/E in expansion mode. These advantages result in a system with graceful degradation, no single point of failure of the entire system, and flexibility to add capability as power and storage requirements increase. It also enables a flow-through mode of operation where energy from a prime mover (such as a wind generator, a wave power generator, a current power generator, a tidal power generator, and an ocean thermal energy converter, as examples) passes through a first C/E, compressing fluid, is optionally stored, and passes through a second C/E in expansion mode, generating energy for the grid. Such an embodiment eliminates ramp/up and ramp/down time for the system, enabling a standby mode of operation that is ready to absorb power or deliver it on demand without delay.

Referring now to FIG. 12, basic components of system 182 positioned at sea that can benefit from an embodiment of the invention are illustrated. Components of system 182 may be positioned on a platform 236 proximately to the water surface. Thus, FIG. 12 illustrates a sea 238 and a sea floor 240. Sea 238 includes an ocean, a lake, or a reservoir such as in a dammed river, and in this and all embodiments is not limited to any specific body of water. System 182 includes a flexible fluid vessel or fluid vessel assembly 242 positioned at an average depth 244, a unidirectional or bi-directional fluid pressure conversion device or compressor/expander (C/E) 246 coupled to a generator 248, and a heat transfer system (pumps and heat exchangers as discussed with respect to FIG. 10, not illustrated). Deployment of fluid vessel assembly 242 may be accomplished using embodiments of the invention described herein. C/E 246 may include multiple stages of compression and expansion, and a heat exchanger package (not shown) may cool or reheat the fluid between the stages of compression or expansion, respectively. The tubes carrying the pressurized fluid are immersed in circulating water, or more commonly, the pressurized fluid is passed over a finned tube heat exchanger inside which flows inside the finned tubes. System 182 may be configured to operate substantially in nearly-isothermal or adiabatic modes.

One skilled in the art will recognize that system 182 of FIG. 12 may include but is not limited to other devices such as a control system, a computer, and one or more clutches to mechanically couple components thereof. The vessel 242 is ballasted so it doesn't float to the surface when inflated.

A fluid hose or pipe, or pressurized-fluid conveyance system 250 connects fluid storage vessel assembly 242 with the C/E 246 at or near the surface of sea 238. The C/E 246 is coupled to generator 248, which in one embodiment is the same generator used by a wind turbine, with a clutch (not shown). The generator 248 can act as a motor as well to drive the C/E 246 in compressor mode when storing energy, or if the wind is blowing, the wind power can be put into the generator 248. Thus, when full power from the system is desired, for example during peak demand periods on the grid, the stored fluid expanding through the C/E 246 augments the torque to the generator 248. In embodiments, generator 248 is an (alternating current) A/C generator, and in other embodiments, generator 248 is a (direct current) DC generator.

DC power transmission is not often used for land-based transmission because of the cost of conversion stations between transmission lines. However, the efficiency of DC transmission lines can be greater than A/C lines, particularly under salt water. Other advantages of DC power transmission include a clearer power flow analysis and no requirement to synchronize between independent grid sections connected by the DC line. Additional benefits of DC transmission may be realized when the lines are run underwater due to capacitance of the transmission line. Thus, many DC transmission systems are in existence today.

C/E 246 provides the ability to both compress and expand fluid. In one embodiment, C/E 246 is a single component that includes the ability to compress fluid when work is input thereto and to expand fluid to extract work therefrom. In such an embodiment, a single fluid hose or pipe 250 is positioned between fluid storage tube assembly 242 and C/E 246, and fluid is pumped to and from fluid storage tube assembly 242 using fluid hose or pipe 250. Thus, when power is input 252 to C/E 246, C/E 246 operates to compress fluid, convey it to fluid storage tube assembly 242 via fluid hose or pipe 250, and store the energy therein. Power 252 may be provided via a renewable source such as wind, wave motion, tidal motion, or may be provided via the generator 248 operated as a motor which may draw energy from, for instance, a power grid. Also, C/E 246 may be operated in reverse by drawing compressed stored energy from fluid storage tube assembly 242 via fluid hose or pipe 250. Thus, by reversing its motion, C/E 246 may be caused to alternatively compress or expand fluid based on a direction of operation or rotation. Note that the generator 248 provides electrical power in one embodiment. Alternatively, mechanical power may be utilized directly from the expander without the use of generator 248.

However, in another embodiment, compressor and expander functionalities of C/E 246 are separated. In this embodiment, an expander 254 is coupled to fluid storage tube assembly 242 via fluid hose or pipe 250, and a compressor 256 is coupled to fluid storage tube assembly 242 via the same fluid hose 250, or, alternatively, a separate fluid hose, pipe, or piping system 258. Thus, in this embodiment, power may be input 252 to compressor 256 via, for instance, a renewable energy source that may be intermittent-providing compressed fluid to fluid storage tube assembly 242 via separate fluid hose or pipe 258. In this embodiment, energy may be simultaneously drawn from fluid storage tube assembly 242 via fluid hose or pipe 250 to expander 254. Thus, while providing the system flexibility to simultaneously store and draw power, this embodiment does so at the expense of having separate compressor 256 and expander 254 (additional compressor and expander not illustrated).

Therefore, according to an embodiment of the invention, a plow for deployment of a flexible vessel includes a body having an outer wall and an inner wall extending along a bore passing through the body. The body also has an intermediate wall extending between the outer wall and the inner wall, wherein a vessel cavity is formed between the inner and outer walls that is configured to receive the flexible vessel in a pre-deployment configuration.

According to another embodiment of the invention, a method for manufacturing a vessel deployment apparatus includes forming a first wall member to surround a bore volume and coupling a second wall member about the first wall member such that a vessel volume is formed between the first and second wall member portions that is capable of receiving a flexible vessel therein for deployment thereof. The method also includes coupling a third wall member to the first and second wall members.

According to yet another embodiment of the invention, a vessel deployment apparatus having a bore extending therethrough includes a first wall member portion positioned at least about a section of the bore and includes a second wall member portion positioned about the first wall, wherein a volume between the first and second wall member portions is capable of receiving a flexible vessel therein for deployment of the flexible vessel. A third wall member portion is coupled between to the first and second wall member portions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A plow for deployment of a flexible vessel comprising:
a body comprising:
an outer wall;
an inner wall extending along a bore passing through the body;
an intermediate wall extending between the outer wall and the inner wall; and
wherein a vessel cavity is formed between the inner and outer walls that is configured to receive the flexible vessel in a pre-deployment configuration.

2. The plow of claim 1 wherein the intermediate wall is configured to direct a portion of a material passing therealong into the bore as the body is translated through the material.

3. The plow of claim 1 wherein the intermediate wall is configured to direct a portion of a material passing therealong away from the bore as the body is translated through the material.

4. The plow of claim 1 wherein the outer wall, the inner wall, and the intermediate wall form a passageway through which a portion of a material passes as the body is translated through the material.

5. The plow of claim 1 further comprising a hoop assembly coupled to the body and positioned within the vessel cavity, the hoop assembly comprising:
a hoop configured to engage a surface of a wall of the flexible vessel;
a retainer configured to engage an exterior surface of the wall of the flexible vessel and keep the hoop assembly in place on the plow.

6. The plow of claim 1 further comprising a vessel tension assembly positioned within the vessel cavity, the vessel tension assembly comprising a plurality of tension members coupled to the body and extending toward one of the inner wall and the outer wall, wherein the plurality of tension members and the one of the inner wall and the outer wall are configured to apply a tension force to the flexible vessel when the flexible vessel is positioned therebetween.

7. The plow of claim 1 further comprising a liquid injection system comprising:
an input port;
a passageway coupled to the input port; and
an output port coupled to the passageway and positioned to output a liquid from a surface of one of the inner wall, the outer wall, and the intermediate wall.

8. The plow of claim 1 further comprising a towing assembly coupled to the body and configured to transfer a towing force to the body such that material from a surface through which the body is towed passes through the body via the bore.

9. The plow of claim 8 wherein the towing assembly comprises:
a plurality of tensile structural elements coupled to the body; and
an adjustment apparatus coupled to a first tensile structural element of the plurality of tensile structural elements, wherein the adjustment apparatus is configured to vary a length of the first tensile structural element to vary an angle of the body on one of a pitch axis and a yaw axis.

10. The plow of claim 1 further comprising a plurality of ski-shaped runners coupled to the outer wall and configured to move along a surface of a material through which the body is translated.

11. A method for manufacturing a vessel deployment apparatus comprising:
forming a first wall member to surround a bore volume;
coupling a second wall member about the first wall member such that a vessel volume is formed between the first and second wall member portions that is capable of receiving a flexible vessel therein for deployment thereof; and
coupling a third wall member to the first and second wall members.

12. The method of claim 11 wherein coupling the second wall member about the first wall member comprises positioning a leading edge of the first wall member closer to a front of the vessel deployment apparatus than a leading edge of the second wall member; and
wherein coupling the third wall member to the first and second wall members comprises coupling the third wall member between the leading edges of the first and second wall member such that a ballast material passing along the third wall member is directed into the bore volume as the front of the vessel deployment apparatus is translated through the ballast material.

13. The method of claim 11 wherein coupling the second wall member about the first wall member comprises positioning a leading edge of the second wall member closer to a front of the vessel deployment apparatus than a leading edge of the first wall member; and
wherein coupling the third wall member to the first and second wall members comprises coupling the third wall member between the leading edges of the first and second wall member such that a ballast material passing along the third wall member is directed away from the bore volume as the front of the vessel deployment apparatus is translated through the ballast material.

14. The method of claim 11 further comprising forming a passageway bounded by at least the first, second, and third wall members, wherein the third wall member is configured to translate material in the passageway from a position under a surface of the material to a position on top of the surface of the material.

15. The method of claim 11 further comprising positioning a deployment assembly within the volume, wherein the deployment assembly is configured to engage a vessel torus and comprises:
a first plurality of rollers configured to engage the vessel torus on a first side of the vessel torus; and
a tension roller configured to engage the vessel torus on a second side of the vessel torus and configured to maintain engagement of the first plurality of rollers with the vessel torus.

16. The method of claim 11 further comprising coupling a plurality of tension members to one of the first and second wall members, wherein the plurality of tension members is configured to apply a tension force to the flexible vessel when the flexible vessel is positioned between the plurality of tension members and the one of the first and second wall members.

17. A vessel deployment apparatus having a bore extending therethrough and comprising:
a first wall member portion positioned at least about a section of the bore;
a second wall member portion positioned about the first wall, wherein a volume between the first and second wall member portions is capable of receiving a flexible vessel therein for deployment of the flexible vessel; and
a third wall member portion coupled between to the first and second wall member portions.

18. The vessel deployment apparatus of claim 17 wherein the third wall member portion is coupled between a leading edge of the first wall member portion and a leading edge of the second wall member portion; and
wherein the third wall member is positioned such that a ballast material passing along the third wall member portion is one of directed through the bore and directed away from the bore as the front of the vessel deployment apparatus is translated through the ballast material.

19. The vessel deployment apparatus of claim 17 wherein a passageway is formed via the first, second, and third wall member portions; and
wherein the third wall member portion is configured to translate material in the passageway from a position under a surface of the material to a position on top of the surface of the material.

20. The vessel deployment apparatus of claim 17 further comprising a tension assembly coupled to the vessel deployment apparatus within the volume, wherein the tension assembly is configured to apply tension to a wall of the flexible vessel during a deployment thereof.
